(19) United States
(12) Patent Application Publication
(10) Pub. No.: US 2014/0067475 A1
(43) Pub. Date: Mar. 6, 2014

(54) SYSTEM AND METHOD FOR COMPUTERIZED MARKET RESEARCH ANALYSIS

(71) Applicants: Jiri SIMONEK, Ostrava (CZ); Jiri SIMONEK, Krnov (CZ); Robert BOHONEK, Ostrava-Poruba (CZ); Daniel HOLESINKY, Vratimov (CZ)

(72) Inventors: Jiri SIMONEK, Ostrava (CZ); Jiri SIMONEK, Krnov (CZ); Robert BOHONEK, Ostrava-Poruba (CZ); Daniel HOLESINKY, Vratimov (CZ)

(73) Assignee: DAP SERVICES A.S., Ostrava (CZ)

(21) Appl. No.: 13/605,457

(22) Filed: Sep. 6, 2012

(51) Int. Cl. G06Q 30/02

(52) U.S. Cl. CPC G06Q 30/0204
USPC 705/7.33

(57) ABSTRACT

A market research computer implemented method for evaluating correlation between an entity and concepts associated with the entity. First, the method includes sending from a database, to many users data indicative of the entity and the concepts. Next, repeatedly performing for each user: collection of data indicative of sub-group of color selections, from a predefined group of colors, for both the entity and the concepts. Next, creating a data structure representing Color Association (CA) profiles respectively for each concept of the specified concepts by aggregating of sub-groups of colors selections by the users in respect of the concepts. Next, creating a data structure representing a Color Association (CA) profile for the entity by aggregating sub-groups of color selections by the users in respect of the entity. Next, calculating correlation between a CA profile of the concepts and the CA profile of the entity and reporting on the correlation results.

### FIELD OF THE INVENTION

The invention is generally in the field of determining correlations between concepts, for various applications, such as market research analysis.

### BACKGROUND OF THE INVENTION

In modem life the ever-increasing availability of products, services and brand names poses difficulty for a customer in selecting the product or brand of interest and poses an even greater challenge on the service/product provider to “guess” what the customer needs and to better target the provider's product/service to designated customers.

To this end, market research analysis aims at giving the product/service providers to a better understanding of how the provider's product/service fits market (customer) needs. Such market research results are often performed by specialists, and the results are strongly dependent on the specific paradigm that is used and on the skills of the expert, which may vary from one individual to the other.

References considered to be relevant as background to the presently disclosed subject matter are listed below. Acknowledgement of the references herein is not to be inferred as meaning that these are in any way relevant to the patentability of the presently disclosed subject matter.

Various computerized techniques have been offered in an attempt to automate and harmonize the market research service, including the following:
http://www.eyetrackingservice.com/—Eye tracking
http://www.simpleusability.com/services/eeg/—Neuromarketing
http://www.millwardbrown.com/Solutions/ProprietaryTools.aspx—Tools of MillwardBrown
http://www.gfk.com/group/services/marketing_segments/index.en.html—Tools of GfK There are known in the art color-based techniques that use color selections by a user as personality tests: see for example http://www.colorquiz.com/.

There are also known in the art psychological tests that are based on association such as the Rorschach test: see for example http://en.wikipedia.org/wiki/Rorschach_test.

There are known in the art few methods that can measure authentic uncensored associations like EEG measuring: see for example
http://en.wikipedia.org./wiki/Electroencephalography or
http://en.wikipedia.org/wiki/Skin_conductance.

With these tools one can measure pure associations as well, but these tools cannot be used widely, as they require special placement, special instruments, etc.

There is a need in the art to provide for a new computerized technique for providing market research analysis. There is a further need in the art for a computerized technique for market research that utilizes a combined color selection and association techniques.

### SUMMARY OF THE INVENTION

There is known a technique that combines color selection and association. A technique discussed in http://www.camethod.com/en/colour-association-method.html is described herein in a general, simplified non-binding manner and for illustrative purposes and clarity only. Note that the specified publication does not disclose how the color association is performed.

Thus, generally speaking, the technique concerns submitting one or more types of impulse (e.g. picture, video, sound) to provoke an association in the person that cannot be consciously influenced, ignored or interrupted. A person produces this association within a nanosecond. From the neuroanatomic point of view, it concerns activation of particular neuronal junctions and synapses. This process is normally not rationally interrupted. Association is likely to occur in any case immediately after the impulse is submitted.

Many associations can then be rationally corrected, for example, using one's previous experience or expectation of outcomes. The person asks questions such as: What is the proper reaction to this? How do I answer this correctly? If I say this, what will the consequences be?

In contrast, in “uncensored” authentic associations provide a very different, deeper and more comprehensive view.

The Color Association (CA) technique is a method that deals with measuring and evaluating these “authentic uncensored associations”. Using this method, impulses are submitted in various forms (words, pictures, films, sounds, eventually smells). These impulses provoke associations to which the person is later instructed to react via colors. After evaluating his/her answers and comparing them with a norm, it is possible to describe the psychological characteristics of his/her association quite precisely.

This is typically achieved with eight colors, or more precisely eight colored spheres. Colors are not used in this diagnostic method in the context of their symbolic meaning as people often think. Colors are not used to represent blue, red, yellow, etc., as such. The reason for using colors in detecting associations and their psychological dynamic in a complexly structured psychological field is that each color represents a part of a physically and exactly measurable frequency field of color radiation. As a result, people are able to apply association with the help of matching colors.

Normally, naming of the colors by a person is not important. It is typically not essential that the person name a certain color in the color sphere as red, orange, fiery red or blood red. It is desired that the color frequency waves pass through the human eye to the brain. Via colors and words, or more precisely the analysis of their associative links, the person is capable of providing experts with basic material, enabling them to describe the dynamics of his/her inner way of experiencing and processing reality.

The on-line sensor of color word associations is an instrument used to capture original associations with the help of colors and after further processing, evaluate them and transform transforming them into results, and conclusions. Even though it may look like “playing with colors”, the psychodiagnostic method of color word associations functions on a neurobiological basis.

The technique of color associations (CA) is a combined projective technique using a palette of eight colors and calibrated sets of words, which can be adjusted according to the focus of a certain technical problem. Monitoring these associations is achieved by using a computerized sensor and appropriate control. It is an approach to diagnostics and intervention advantageous over those previously known hi classical psychology or psychiatry, where colors have been used in reputable psychological methods for a very long time (knowledge of colors was employed by ancient Chinese and Sumerian philosophers, by Joseph Wolfgang Goethe, Max Planck and most prominently by Dr. Max Luscher [author of the The Lüscher Colour Test, see http://en.wikipedia.org/wiki/Max_L%C3%BCscher]).

Lüscher first pointed out the transcul rural transferability that the colors show This assumption was then additionally confirmed by the most recent studies of the human brain, which registered extensive webs of neurons working on processing colors, time and space that are not dependent on the cultural environment in which the individual or the group lives. Hence, the color selection will not be affected by the country of residence of the individual, for instance an individual leaving in the US will not have a different choice of an individual living in the Czech Republic for the mere reason that he lives in different country and was exposed to a different culture.

This combined technique of color choice and association is one of the so-called blind techniques. This means that the respondent has very little opportunity to adjust his/her answers to the expectations and opinions of others. During testing, he/she is not limited by the quantity or quality of available information or the level of his/her rational thinking. This is because the respondent uses association mechanisms, which may be regarded as uniform in all people.

In accordance with an aspect of the presently disclosed invention, there is provided a market research computer implemented method for evaluating correlation between an entity and at least one concept associated with the entity, comprising:
a) sending from a database, to each user of a plurality of users data indicative of the entity and the at least one concept associated therewith;
b) repeatedly performing for each user of said plurality of users:
   (i) collecting from the user data indicative of sub-group of color selections, from a predefined group of colors, for said entity and the at least one concept, respectively;
c) creating a data structure representing Color Association (CA) profiles respectively for each concept of said at least one concept by aggregating selections of sub-groups of colors of the plurality of users in respect of said concept;
d) creating a data structure representing a Color Association (CA) profile for said entity by aggregating sub-groups of color selections of the plurality of users in respect of said entity;
e) calculating correlation between a CA profile of at least one of said concepts and the CA profile of said entity; and
f) reporting correlation results indicative on how the plurality of users conceive the correlation between the entity and each one of the at least one concept.

In accordance with an embodiment of the presently disclosed subject matter, there is provided the method wherein said (e) includes, transforming said correlation results into graphical indicators.

In accordance with an embodiment of the presently disclosed subject matter, there is further provided the method wherein said aggregating includes designating the number of users that selected each sub group of colors respectively.

In accordance with an embodiment of the presently disclosed subject matter, there is yet further provided the method wherein each concept is represented by a member of a group that includes: a word, a word phrase, an image, a sound, video, a multi-media.

In accordance with an embodiment of the presently disclosed subject matter, there is yet further provided the method wherein at least one of said concepts is associated with least two objects and said method further comprising in respect of each one of the concepts

said (b) includes
(b1) repeatedly perforating for each user of said plurality of users:
   (i) collecting from the user data indicative of sub-group of color selections, from a predefined group of colors, for said at least two objects, respectively;

arid wherein said (d) includes
(d1) (i) creating a Color Association (CA) profiles respectively for each object of said at least two objects by aggregating sub-groups of color selections of the plurality of users in respect of said concept;
   (ii) creating a CA profile for the concept that is associated with said at least two objects, including normalizing the CA profile of said concept;

and wherein said (e) includes
e1) calculating correlation between the normalized CA profile of said concept and the CA profile of said entity; and wherein said (f) includes
f1) reporting correlation results indicative on how the plurality of users conceive the correlation between the entity and said concept that is associated with at least two objects.

In accordance with an embodiment of the presently disclosed subject matter, there is yet further provided the method wherein each object is represented by a member of a group that includes: a word, a word phrase, an image, a sound, video, a multi-media.

In accordance with an embodiment of the presently disclosed subject matter, there is yet further provided the method wherein said predefined group of colors include seight colors.

In accordance with an embodiment of the presently disclosed subject matter, there is yet further provided the method wherein said sub-group of colors includes three colors.

In accordance with an embodiment of the presently disclosed subject matter, there is yet further provided the method wherein said correlation utilizes the Piersan correlation technique.

In accordance with an embodiment of the presently disclosed subject matter, there is yet further provided the method wherein said entity being represents a car brand.

In accordance with an aspect of the presently disclosed invention, there is provided a market research computer implemented method for evaluating at least one parameter associated with an entity, comprising;
a) sending from a database a collection of reference sub-group selections in respect of at least one parameter associated with said entity;
b) repeatedly performing for each user of said plurality of users:
   (i) collecting from the user data indicative of sub-group color selections, from a predefined group of colors, for said entity;
c) calculating a non-correlation function in respect of the user sub-group selections using data that is obtained from the reference sub-group selections, wherein said function corresponds to a parameter, and determining the level of correspondence between the parameter and said entity in respect of said plurality of users; and
d) reporting correspondence results indicative on how the plurality of users conceive the correspondence between the entity and each one of the at least one parameter.

In accordance with an embodiment of the presently disclosed subject matter, there is provided the method wherein each parameter is represented by a member of a group that includes: a word, a word phrase, an image, a sound, video, a multi-media.

In accordance with an embodiment of the presently disclosed subject matter, there is further provided the method wherein said predefined group of colors includes eight colors.

In accordance with an embodiment of the presently disclosed subject matter, there is yet further provided the method wherein said sub-group of colors includes three colors.

In accordance with an aspect of the presently disclosed invention, there is provided a market research computer implemented system for evaluating correlation between an entity and at least one concept associated with the entity in respect of a plurality of users, comprising:
an analyzer module is configured to provide a data structure representing Color Association (CA) profiles respectively for each concept of said at least one concept by aggregating sub-groups of color selections of the plurality of users in respect of said concept;
the analyzer module is further configured to provide a data structure representing a Color Association (CA) profile for said entity by aggregating sub-groups of color selections of the plurality of users in respect of said entity;
said analyzer module is configured to calculate correlation between a CA profile of at least one of said concepts and the CA profile of said entity; and
a report module coupled to said analyzer module and being configured to report on correlation results indicative on how the plurality of users conceive the correlation between the entity and each one of the at least one concept.

In accordance with an embodiment of the presently disclosed subject matter, there is provided the system further comprising a scanner control module coupled to said analyzer module and being configured to send to each user of a plurality of users data indicative of the entity and the at least one concept associated therewith; said scanner control module is configured to extract said data from a database;
said scanner control module is further configured to collect from said plurality of users data indicative of sub-group of color selections, from a predefined group of colors, for said entity and the at least one concept, respectively.

In accordance with an embodiment of the presently disclosed subject matter, there is further provided the system further comprising
Said analyzer module is further configured to calculate a non-correlation function between the user sub-group selections and the reference sub-group selections in respect of said at least one parameter and determining the level of correspondence between the parameters and said entity in respect of said plurality of users; and

1said report module is further configured to report on correspondence results indicative on how the plurality of users conceive the correspondence between the entity and each one of the at least one parameter.

In accordance with an aspect of the presently disclosed invention, there is provided a program storage device readable by machine, tangibly embodying a program of instructions executable by the machine to perform method steps for computer implemented market research, comprising:
a) sending from a database, to each user of a plurality of users data indicative of the entity and the at least one concept associated therewith;
b) repeatedly performing for each user of said plurality of users:
   (i) collecting from the user data indicative of sub-group of color selections, from a predefined group of colors, for said entity and the at least one concept, respectively;
c) creating a data structure representing Color Association (CA) profiles respectively for each concept of said at least one concept by aggregating selections of sub-groups of colors of the plurality of users in respect of said concept;
d) creating a data structure representing a Color Association (CA) profile for said entity by aggregating sub-groups of color selections of the plurality of users in respect of said entity;
e) calculating correlation between a CA profile of at least one of said concepts and the CA profile of said entity; and
f) reporting correlation results indicative on how the plurality of users conceive the correlation between the entity and each one of the at least one concept.

In accordance with an aspect of the presently disclosed invention, there is provided a program storage device readable by machine, tangibly embodying a program of instructions executable by the machine to perform method steps for computer implemented market research, comprising:
a) sending from a database a collection of reference sub-group selections in respect of at least one parameter associated with said entity;
b) repeatedly performing for each user of said plurality of users:
   (i) collecting from the user data indicative of sub-group color selections, from a predefined group of colors, for said entity;
c) calculating a non-correlation function in respect of the user sub-group selections using data that is obtained from the reference sub-group selections, wherein said function corresponds to a parameter, and determining the level of correspondence between the parameter and said entity in respect of said plurality of users, and
d) reporting correspondence results indicative on how the plurality of users conceive the correspondence between the entity and each one of the at least one parameter.

### BRIEF DESCRIPTION OF THE DRAWINGS

In order to understand the presently disclosed subject matter and to see how it may be carried out in practice, the subject matter will now be described, by way of examples only, with reference to the accompanying drawings, in which:

FIG. 1A is a general outline of the system architecture, in accordance with certain embodiments of the invention;

FIG. 1B illustrates a generalized outline of a scanner user interface;

FIG. 2 is a flow chart of a general sequence of operation, in accordance with certain embodiments of the invention;

FIG. 3A is a flow chart of a scanner processing sequence of operations, in accordance with certain embodiments of the invention;

FIG. 3B illustrates an exemplary Color Association profile data record, in accordance with certain embodiments of the invention;

FIG. 4A is a flow chart of a correlation processing, in accordance with certain embodiments of the invention;

FIG. 4B is a flow chart of a normalization sequence of operation, in accordance with certain embodiments of the invention;

FIG. 4C illustrates exemplary correlation histogram results, in accordance with certain embodiments of the invention;

FIG. 4D is a flow chart of a non-correlation processing, in accordance with certain embodiments of the invention; and

FIG. 5 is a flow chart of a normalizing sequence of operation for reporting results, in accordance with certain embodiments of the invention.

### DETAILED DESCRIPTION OF SPECIFIC EMBODIMENTS

Unless specifically stated otherwise, as apparent from the following discussions, it is appreciated that throughout the specification discussions utilizing terms such as “sending”, “collecting”, “performing”, “creating”, “aggregating”, “calculating”, “reporting”, “providing” or the like, include action and/or processes of a computer that manipulate and/or transform data into other data, said data represented as physical quantities, e.g. such as electronic quantities, and/or said data representing the physical objects. The term “computer” should be expansively construed to cover any kind of electronic device with data processing capabilities, including, by way of example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a computer readable storage medium.

As used herein, the phrase “for example,” “such as”, “for instance”, “e.g.” and variants thereof describe certain embodiments of the presently disclosed subject matter.

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

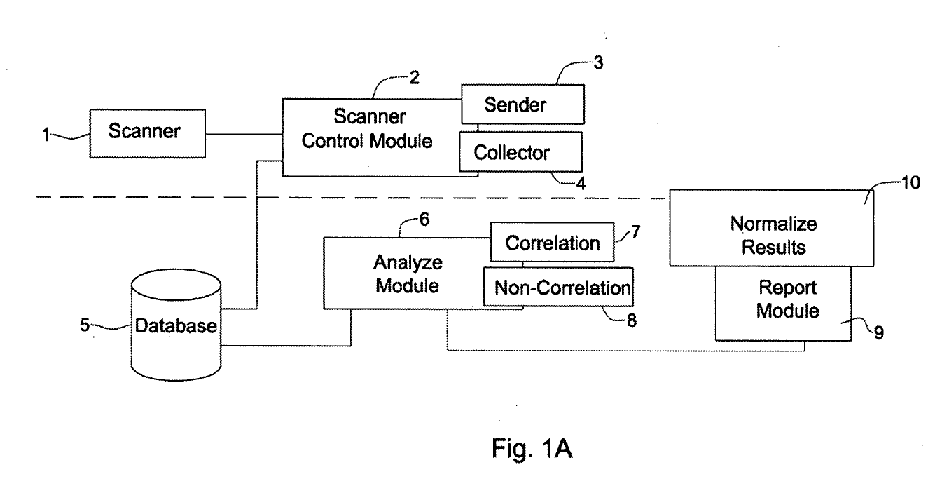

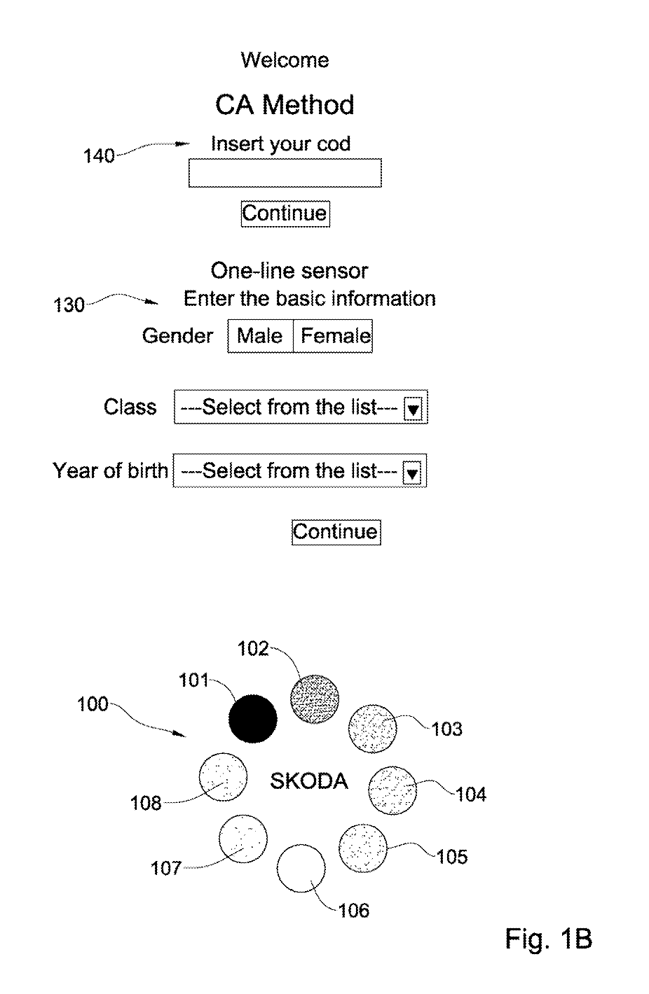

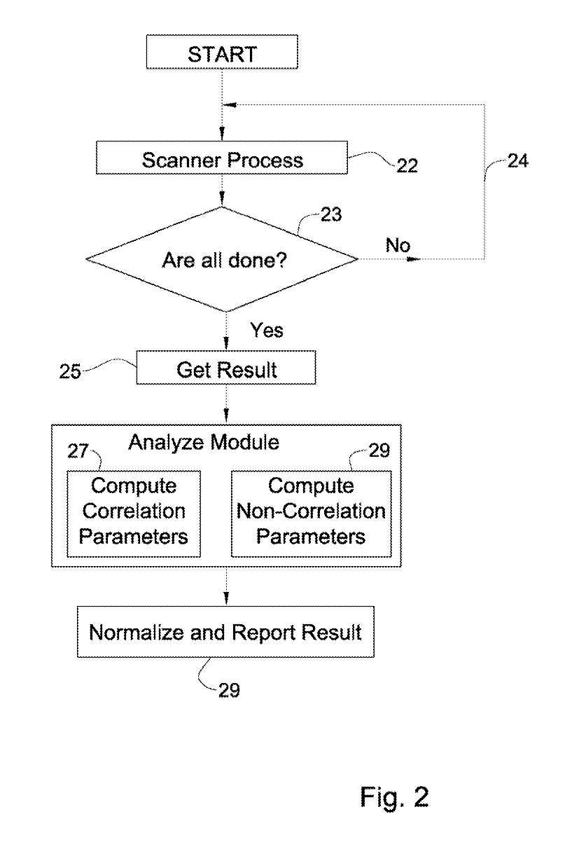

In embodiments of the presently disclosed subject matter, fewer, more and/or different stages than those described with reference to FIGS. 2, 3A, 4A, 4B, 4D and 5 may be executed. In embodiments of the presently disclosed subject matter one or more stages described with reference to FIGS. 2, 3A, 4A, 4B, 4D and 5 may be executed in a different order and/or one or more groups of stages may be executed simultaneously. FIG. 1A illustrates a general schematic of the system architecture in accordance with an embodiment of the presently disclosed subject matter. Each module (e.g. analyzer module, scanner control module) in FIG. 1A can be made up of any combination of software, hardware and/or firmware that performs the functions as defined and explained herein. The modules in FIG. 1A may be centralized m one location or dispersed over more than one location (e.g. cloud). In other embodiments of the presently disclosed subject matter, the system may comprise fewer, more, and/or different modules than those shown in FIG. 1A.

Bearing this in mind, attention is first drawn to FIG. 1A illustrating a general outline of the system architecture, in accordance with certain embodiments of the invention. The system aims at performing a computerized market (utilizing computer modules) research analysis of an entity utilizing a combination of colors and association. As shown, a scanner control module 1 normally operable at a user node interfaces with the user for receiving the user's color input selection. The scanner module is communicating, e.g. through the Internet, with a remote scanner control module 2, which utilizes sender and collector modules (3 and 4 respectively). As will be explained in greater detail below, the sender module will send to the scanner module data indicative of a series of concepts, one or more of which may be associated with two or more objects. The concepts are associated with an entity of interest. The sender also sends data indicative of a group of colors, say 8. In response to the submission of the objects, the scanner module will receive from the user data indicative of a color selection, say a subgroup of 3 selected colors in respect of each displayed object. The user's data indicative of color selections will be collected by the collector module 4 and stored in a database 5. The procedure will be repeated in respect of each one of a group of users. The user group's size may be determined based on the specific requirement, depending upon the particular application. In response to a command for invoking the computerized market research, an analyzer module 6 is activated and utilizes the so stored data (in known per se database 5) for constructing a data structure of Color Association (CA) profiles data structure, (which CA profiles represent concepts, all as will be explained in greater detail below. The CA profiles that are representative of concepts will be subject to correlation processing by a correlation processing module 7. As will be further discussed below, certain color selections will be subjected to non-correlation processing by a non-correlation processing module 8, both forming part of the analyze module 6.

Having finalized the analyzing processing, a reporting module 9 is invoked, which may include applying normalization process by a result normalization module 10 for obtaining normalized market research results, which will be reported (e.g. displayed).

Thus, in accordance with an aspect of the invention there is provided a market research computer implemented system (e.g. in accordance e.g. with the system architecture of FIG. 1A) for evaluating correlation between an entity and at least one concept associated with the entity in respect of a plurality of users, comprising:

An analyzer module 6 is configured to provide (e.g. generate of extract from database 5) a data structure representing Color Association (CA) profiles respectively for each concept of said at least one concept by aggregating sub-groups of color selections of the plurality of users in respect of said concept.

The analyzer module 6 is further configured to provide (e.g. generate of extract from database 5) a data structure representing a Color Association (CA) profile for said entity by aggregating sub-groups of color selections of the plurality of users in respect of said entity.

The analyzer module 6 is configured to calculate (e.g. utilizing modle 7) correlation between a CA profile of at, least one of said concepts and the CA profile of said entity.

A report module 9 coupled to said analyzer module 6 and being configured to report on correlation results indicative on how the plurality of users conceive the correlation between the entity and each one of the at least one concept.

Note that the system may further include a scanner control module 2 coupled to the analyzer module 6 and being configured to send (e.g. through sender module 3) to each user of a plurality of users data indicative of the entity and the at least one concept associated therewith. The scanner control module 2 is configured to extract said data from a database 5.

The scanner control module 2 is further configured to collect (e.g. through collector module 4) from said plurality of users data indicative of sub-group of color selections, from a predefined group of colors, for said entity and the at least one concept, respectively.

The analyzer module 6 may be further configured to calculate a non-correlation function (e.g. utilizing module 8) in respect of the user sub-group selections, using data that is obtained from the reference sub-group selections (where each function is unique to a given evaluated parameter). The result of the calculated function will determine the level of correspondence between the parameter and said entity in respect of said plurality of users.

The report module 9 may be further configured to report on correspondence results indicative on how the plurality of users conceive the correspondence between the entity and each one of the at least one parameter.

Those versed in the art will appreciate that the terms sending and/or receiving and/or collecting and/or storing (i) data indicative of object(s)/color(s)/group of colors, or (ii) object(s)/color(s)/group of colors (while avoiding the use of “data indicative of”) are used interchangeably.

Note also that the invention is not bound by the system architecture depicted in FIG. 1. Thus, for example, the invention is not bound by utilization of any specific database and/or by specific data structure for representing the CA profiles. By way of another example, one or more of the modules may be modified and or split to distinct modules and/or two or more of the modules may be consolidated into a single module and/or some or all of the modules may be organized in a different module architecture.

Attention is now drawn, to FIG. 1B, illustrating a generalized outline of a scanner user interface. As shown, the user is prompted with a sphere 100 of say 8 colors (where for instance the circle 101 represents a grey color that is displayed to the user, the circle 102 represents a green color and so forth for brown, red, black, yellow,, purple and blue (103 to 108, respectively). Note also that the invention is not bound by particular colors and accordingly any color that falls in the rainbow of spectrum of the visible light may be selected, depending upon the particular application.

In addition, the entity of interest (in this particular example, a word, say Skoda™ 109) is displayed, and the user is requested to select a subgroup of colors (say 3) that is intuitively associated with the displayed object.

Note that the invention is not bound by the specific display of FIG. 1B including any of (i) the group size of the displayed colors, (ii) the subgroup size, (iii) the particular colors that, compose the group, (iv) the shape (sphere) in which the group of colors is displayed, (v) the form (e.g. circle) of each color, and (vi) the specific layout of displaying the object and the group of colors.

Attention is now drawn to FIG. 2 illustrating a flow chart of a general sequence of operation, in accordance with certain embodiments of the invention. Thus, at the onset, a scanning sequence 22 commences, which includes sending to the user (say through sender module 3 of FIG. 1) the group of colors and the objects as extracted from the database and collecting the user's subgroup selections (say through collector module 4). The so collected data are then stored at the database. This procedure is repeated (23, 24) until all the selections from each user are finalized, and the same procedure is applied to each one of X users (say about 500) depending on the desired statistical sample requirements.

Obviously, the procedure of collecting the sampled data from ail users may take a while.

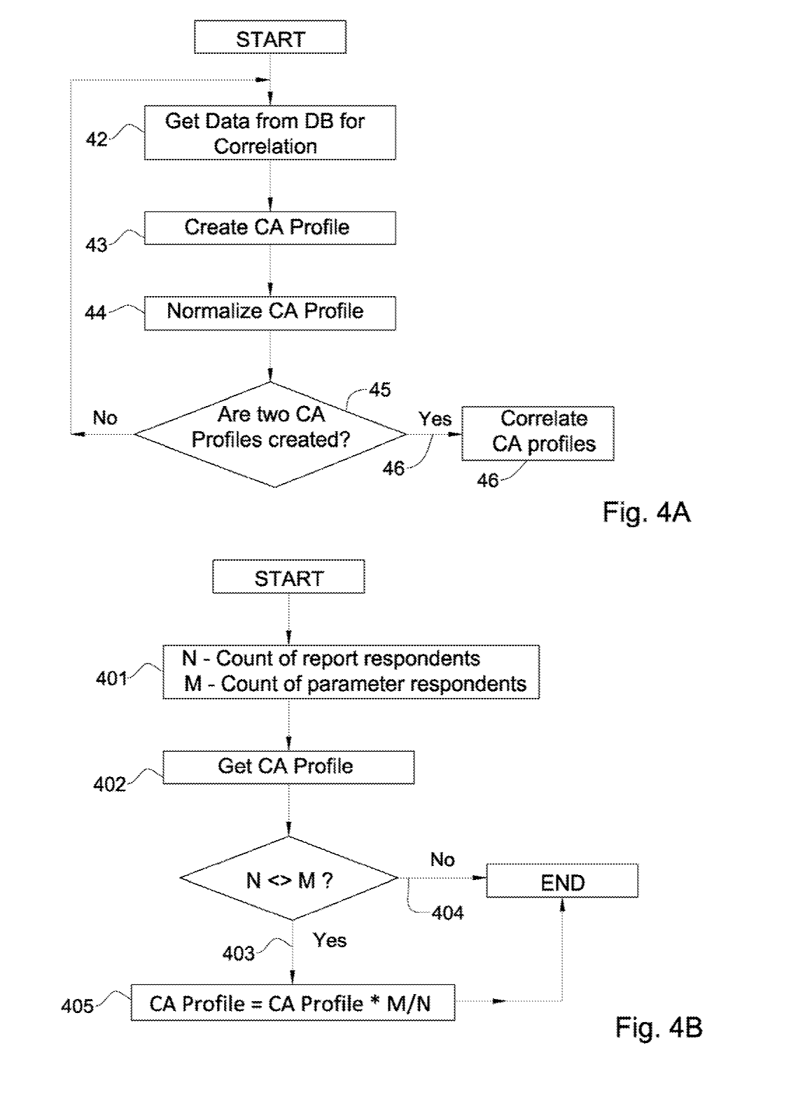

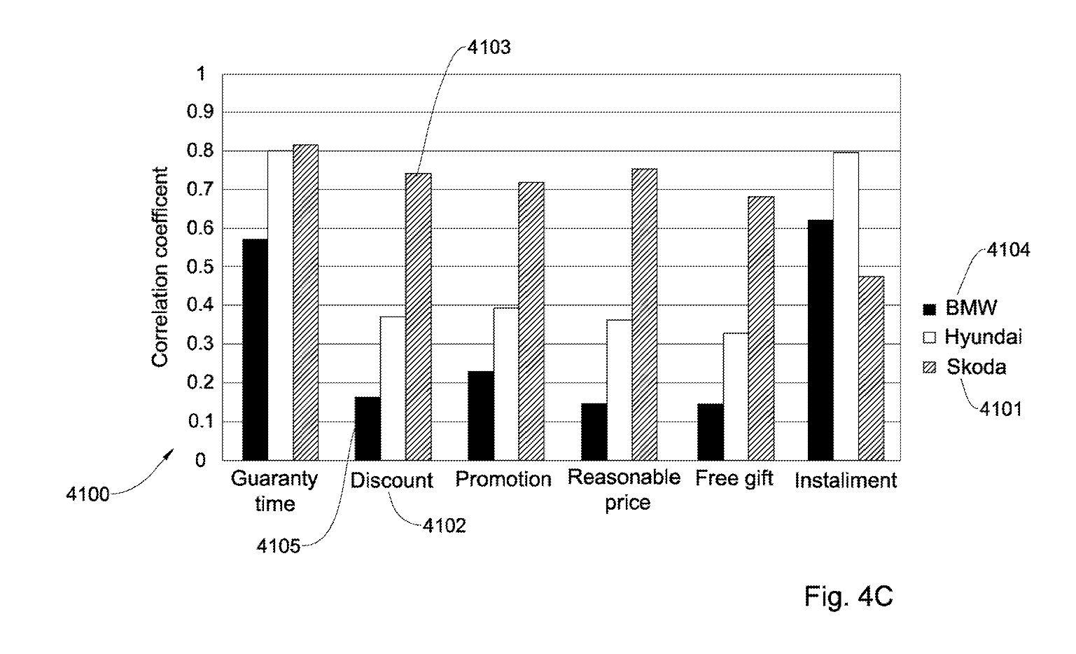

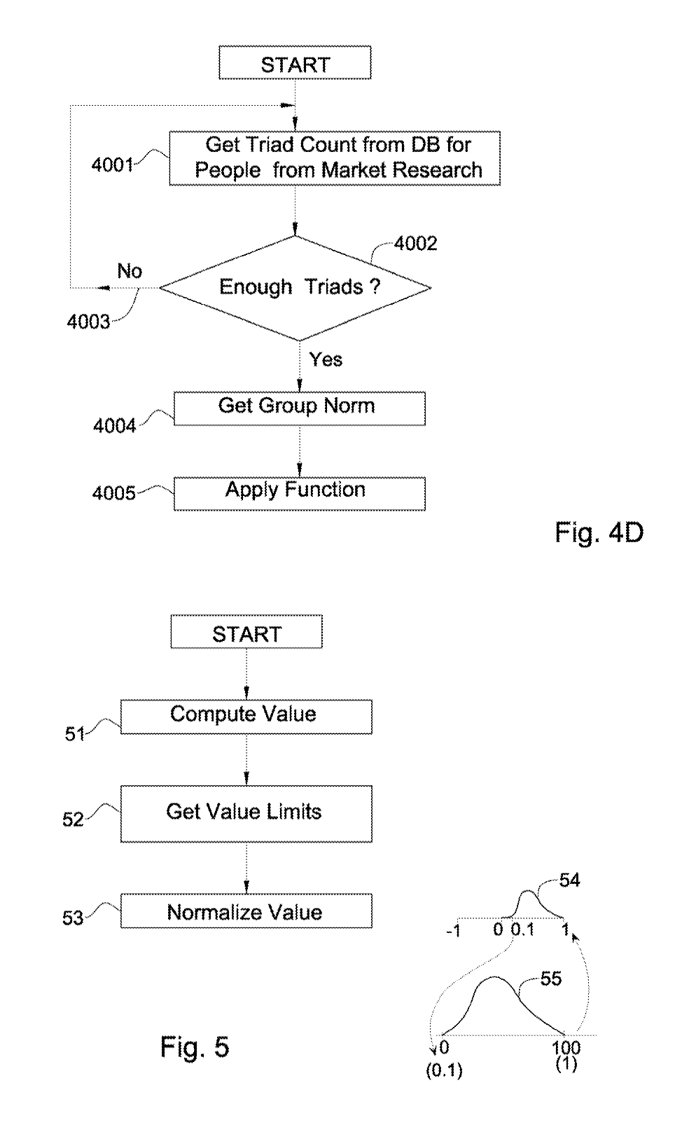

When all the required data is available in the database, and in response to invoking a starting command for the market research analysis, the so stored results are extracted from the database 25 and are converted to Color Association (CA) profile data records representation (in the case that they were not stored in this manner at the end of the scanning process). Note that the conversion to CA profile is only applicable for “correlation” analysis and not to “non-correlation” analysis, all as will be explained in greater detail below. Then, an analysis sequence commences 26 that includes a correlation processing 27 and a n on-correlation processing 28, all as will be explained in greater detail with reference to FIGS. 4A-C. Finally, the so obtained results are subjected to normalization and are reported, e.g. displayed 29.

Note that the invention is not bound by the specified sequence of operations of FIG. 2, and accordingly one or more of the steps may be modified and/or other step(s) may be added.

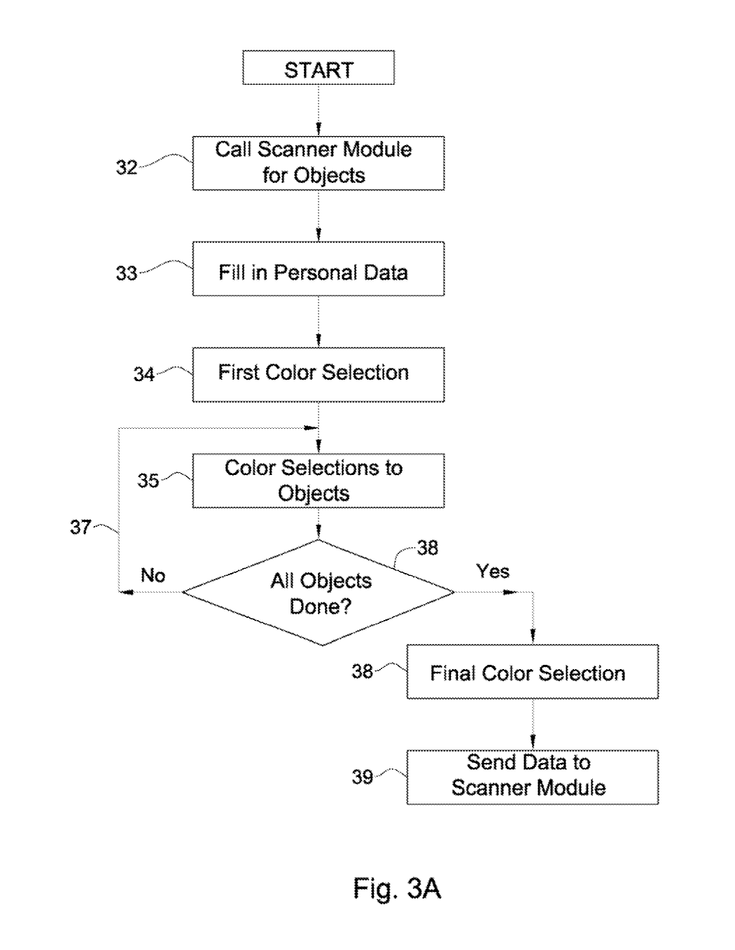

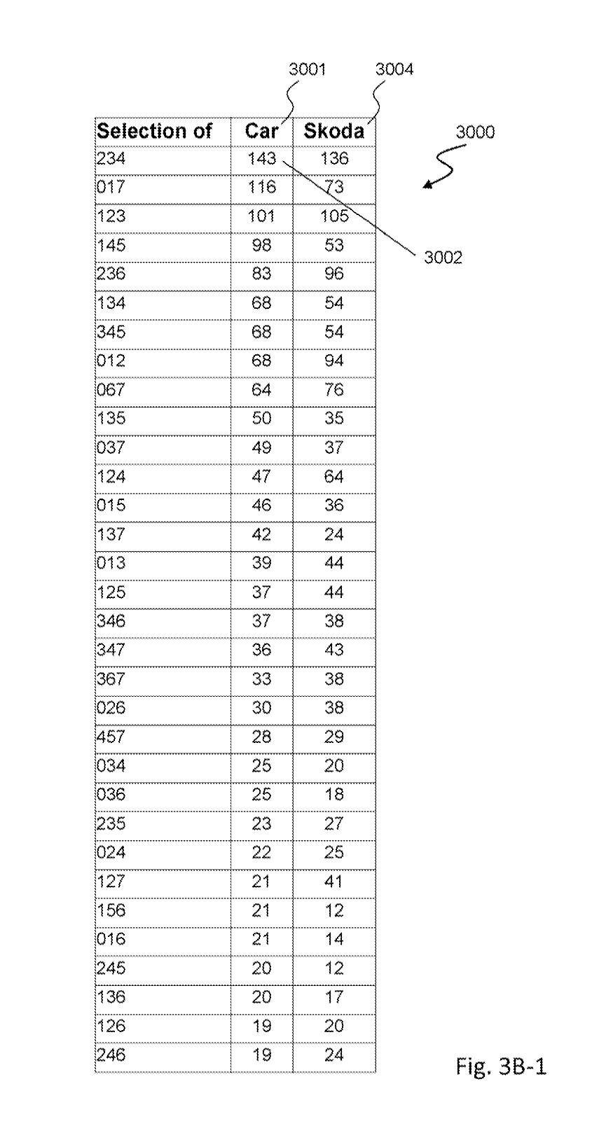

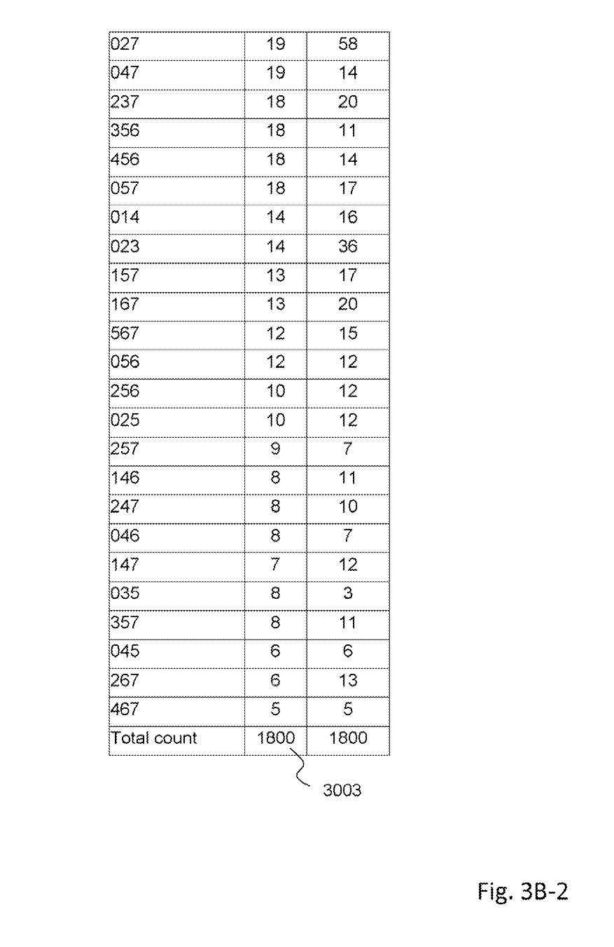

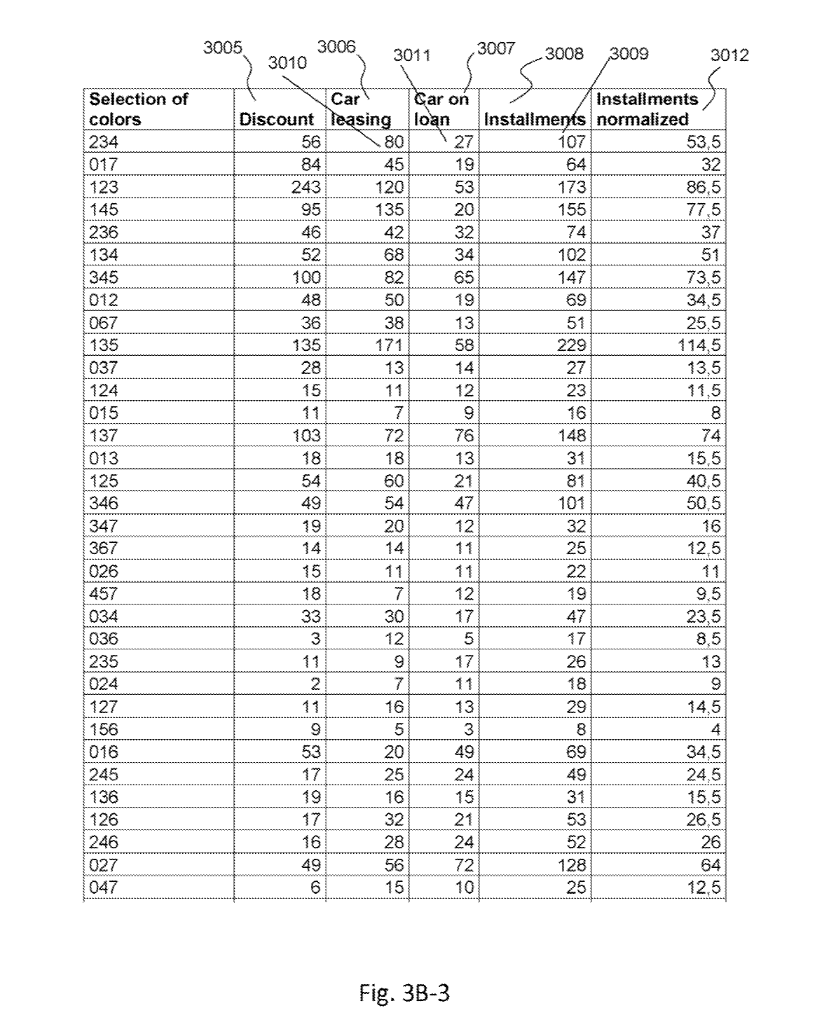

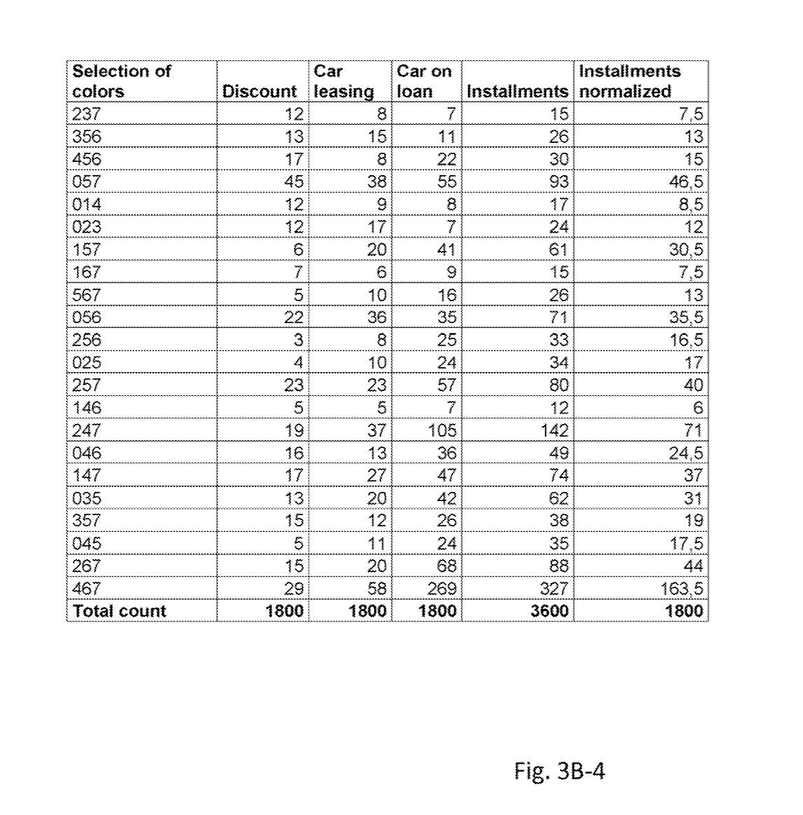

Turning now to FIG. 3A, it illustrates a flow chart of a scanner processing sequence of operations (step 22 of FIG. 2), in accordance with certain embodiments of the invention. Thus, at the onset (step 32 ), the scanner informs the scanner control module which test to apply through a unique code (e.g. a given code that corresponds to a market research test). For example, each entity (say market research that pertains to a car model Skoda™) will have a given code whereas market research for a different entity will have a different code followed by filling in of personal data 33 such as gender and age (see also in FIG. 1B exemplary screen shots 140 for the unique code and 130 for the personal details). Then, based on the so identified test (according to the code number), the scanner accesses the database to retrieve the set of objects that correspond to concept(s) associated with the tested entity. Then, a first color selection is sent from the sender control module to the sender module at the user end 34 (see also color layout 100 of FIG. 1B). The user marks the order of the group of S colors, starting from color X and so forth, until all the colors of the group are marked. The user's selection (i.e. the ordered 8 colors) is collected by the collector module and stored in the database.

Then, there commences a sequence of sending objects (starling with tire entity concept, say Skoda™) and the group colors and in response the user selects a subgroup of 3 colors per object for as many objects as the test prescribes (steps 35 to 37). Note that the entity concept does not necessarily have to be the first one in the series. Note, also that the selections for two or more objects may be “classified” to a given concept. Consider, for example, market research that aims at slicing the market reaction to the entity Skoda™ in respect of the concepts “discount” and ∫installments”, which signify whether a customer when considering Skoda™ would expect his car dealer to offer him a discount and whether he would be willing to consider paying for the car in installments. Insofar as the concept “discount” is concerned, it is composed of, e.g., a single word object “discount” whereas for the concept “installments” it is composed of, say, the two object words “car on leasing” and “car on loan”. The invention that concerns market research for a car in general and Skoda™ in particular is obviously not bound by the specified concepts and/or word objects. Note that the term “word” may refer also to “word phrase” (i.e. any combination of two or more words), where the case may be. The invention is of course not bound by the specified word object (concept) examples. Other non-limiting word object (concept) examples may be “advertisement”, “guarantee time”, “free gift”, or “usable”.

Reverting now to FIG. 3A, as discussed with reference to steps 35 to 37, for each of the specified word objects (Skoda™, discount, car on leasing, and car on loan) the user selects in the scanner, and the collector module collects 39 the corresponding subgroup selections. In this particular example, this means four sub-group selections, each including a selection of three colors as well as a final color selection 38, which includes marking of a series of ordered colors selection, starting from color Y and moving on until all the colors that constitute the group (in this example 8) are marked. The procedure is repeated for the entire statistics sample model of say 1800 users, and the appropriate collected color subgroup selections in respect of their corresponding objects are stored in the database (not shown in FIG. 3A).

Note that the invention is not bound by any particular communication protocol for exchanging communication between the scanner and the sender/collector modules and likewise not by the manner of representing colors in the transmissions, display and in the database. Note also that the invention is not bound by the specified sequence of operations of FIG. 3A, and accordingly one or more of the steps may be modified and/or other step(s) may be added.

Attention is now drawn to FIG. 3B, illustrating an exemplary Color Association profile data record in accordance with certain embodiments of the invention, and to FIG. 4A, illustrating a flow chart of a correlation processing, in accordance with certain A embodiments of the invention. As shown in FIG. 3B, a CA profile data structure 3000 includes, e.g. for the object “car”, a column 3001 designating all possible sub-group combinations (where, for convenience, each color from among the eight is assigned a number ranging from 0 to 7). Thus, as shown in column 3001, all 56 possible combinations of 3 colors out of a group of 8 colors are indicated (starting from 234 and ending at 467). Note that while in certain embodiments there is no importance to the order in which the subgroup is selected (i.e. 234, 243, 324, 342. 423 and 432 are all considered the same subgroup selection “234”), this is not necessarily always the case, and accordingly for other embodiments of the invention the order of some or all the subgroup selections may be of significance. Cell 3002 designates the number of participants (143) that selected the 234 subgroup. The total hits for all the sub-groups amounts for the total participants, in this example, are 1800 (3003).

FIG. 3B further shows the CA profile record for the object “Skoda™” 3004. The invention is not bound by the specified data structure of the CA profile and other known per se data structures may be utilized. Note that the invention is not bound by the specified data structure for representing Color Association profile(s). Thus, the data structure may be in any known per se form and may represent distinct or combination of CA profiles ail depending upon the particular application. Moreover, the CA profile may include data other than the color sub-group selections and the corresponding number of users.

Turning now to FIG. 4A, the correlation sequence of operations commences by extracting the relevant data from the database 42 and constructing CA profile in the manner specified (43). Obviously in the case that the specified CA profile was already stored in a CA form in the Database following the previously described scanner operation, then step 43 may be skipped. In the case that the correlation is performed in respect, of CA profiles that represent a different number of participants (e.g. a first CA profile represents 1800 participants and the other represents a lesser number—see example below), then a normalization step is performed 44, all as will be explained in greater detail below with reference to FIG. 4B.

Having obtained two CA profiles as candidates for correlation 45 (e.g. “Skoda™” and “discount”) by repeating the specified steps 42-43 and apply normalization 44 if necessary, a correlation procedure is performed 46, e.g. utilizing the known Pearson or Power Pearson correlation techniques.

As is well known, a measure of dependence between two quantities is the Pearson product-moment correlation coefficient, or “Pearson's correlation” (see http://en.wikipedia.org/wiki/Pearson_product-moment_correlation_coefficient). It is obtained by dividing the covariance of the two variables by the product of their standard deviations. The Pearson correlation is +1 in the case of a perfect positive (increasing) linear relationship (correlation), −1 in the case of a perfect decreasing (negative) linear relationship (and correlation), and some value between −1 and 1 in all other cases, indicating the degree of linear dependence between the variables. As it approaches zero, there is less of a relationship (closer to un correlated). The closer the coefficient is to either −1 or 1, the stronger the correlation between the variables.

Note that the invention is not bound by the specified Pearson correlation technique, and accordingly other correlation techniques may be utilized. The correlation technique will be exemplified, below in respect of CA profiles that in this particular example represent cars (or, for instance, in other examples each CA may represent a group of cars). The invention is obviously not bound by these examples.

Note that the invention is not bound by the specified sequence of operations of FIG. 4A and accordingly one or more of the steps may be modified and/or other step(s) may be added.

Turning now to FIG. 4B, it illustrates a flow chart of a normalization sequence of operation, in accordance with certain embodiments of the invention. Thus, in the case of two CAs of different sizes, say a first CA that accommodates color subgroup selections from N participants and another CA that accommodates color subgroup selections from M<>N participants 9 (401 to 403), then a normalization is applied (405) where each value in the CA profile that represents the smaller group is normalized by applying a M/N normalization factor to any value in the profile (as will be exemplified below). In the case that M=N (404), there is no need for normalizing the CA profile values.

Note that in certain embodiments, there is no need to perform the normalization step in case of correct statistics sample of input data. Thus, for example, if there is a need to find out association between Skoda™ and a tested population (according to gender) and input sample is substantially balanced by gender, then normalization step is obviated. Note that both male and female samples must have sufficient group size (say at least 700 participants each).

For a better understanding of the foregoing, there follows a non-limiting example of the correlation operation. Reverting thus to FIG. 3B, it illustrates CA profile data structures for the entities “car” and “Skoda” for 1800 users (collected e.g. with a confidence interval of ±2.34% on 95% significance level for a frequency of 50%). As further shown in FIG. 3B, additional exemplary CA profiles are shown for the object words “discount” 3005 (representing the concept “discount”) “car leasing” 3006 and “car on loan” 3007 (the latter two “car leasing” and “car on loan” represent the concept “installments”). Note, incidentally, that in accordance with certain embodiments, equivalent term(s) may be used as object and/or concepts; for example, “car leasing” is equivalent to “car on lease” and both are referring to the same object.

Moving on with FIG. 3B, each of the specified CA profiles includes the participants' selections with respect to the 56 available subgroup choices. A CA profile for the concept “installment” 3008 is constructed by simply adding the values of the corresponding sub-group selections. For instance, the value for the color subgroup selection “234” for the concept “installments” 107 (3009) is composed of summing the corresponding values of the “234” color sub-group selections for the “car leasing” and “car on loan” objects (3010 and 3011) that constitute the “installments” concept Obviously, the CA profile for the “installments” profile 3008 will represent 3600 participants (the sum total of participants for both objects). Then, as per step 44 (and as was described in FIG. 4B), a normalization is applied by multiplying each value by a normalization factor of 0.5 (M=1800, N=3600=>M/N=0.5), giving rise to a normalized installment CA profile 3012.

Next, a correlation procedure (e.g. following the specified Pearson technique) is applied to two CAs (step 46 of FIG. 4A), giving the following results between the CA profile of “Skoda™” and the CA profile of “discount” and between the CA profile of “Skoda™” and the CA profile of “normalized installment” (indicative of the normalized installment concept) as shown in FIG. 4C.

Thus, as shown, the correlation between Skoda™ 4101 and Discount 4102 is reflected in bar 4103 of histogram graph 4100 and is relatively high (above 0.7), indicative of the fact that customers of Skoda™ expect their car dealer to provide them a discount when purchasing the ear Skoda™. By way of example, for the car BMW™ 4014, the customers have less expectation of a discount 4105 as arises from the lower value of 0.2. Obviously, the results for BMW™ were achieved by applying the procedure described above with reference to FIG. 1

Before turning to FIG. 4D, it should be noted that unlike the correlation that occurs between the CA profiles that represent objects (or more specifically user color subgroup selections that were associated with objects, say words), it has been found that for certain terms there is no need to present to the user the actual term to get user association by a color subgroup selection. Thus, and as will be exemplified in greater detail below, insofar as (for instance) market research for a car model is concerned, the customer may have “emotion” (exemplifying an implicit parameter) in respect of the tested car model, namely, certain brands may excite the customer when he considers buying them, e.g. a ear equipped with a powerful engine that is associated with a fast drive and therefore may be regarded as exciting.

Another term may be, for example, “relationship” (exemplifying another implicit parameter). Thus, for some customers, a given ear model may be conceived as generating “relationship”, namely, when the customer buys this car brand, he will develop a “relationship” in the sense, that he is likely to possess the car for a longer period and postpone a decision to sell it and buy a newer model. It has thus been found that when the tested entity, say Skoda™, is presented to a user, he will pick a subgroup color selection without explicit exposure to the word “emotion” and/or “relationship” (i.e. no exposure to the implicit parameters), in other words, his subgroup color choice (e.g. the choice of 3 colors) will implicitly “refer” also to the specified implicit parameters even though these terms are not explicitly displayed to him.

In accordance with certain embodiments, there exists reference data (e.g. group norm) collected at least from numerous customers that previously participated in market research and which reference data was derived using subgroup selections that correspond to the implicit parameters under consideration (e.g. the specified “emotion” or “relationship”). The subgroup color selections of a customer that currently participate in the market research will serve for calculation of non-correlation function (that corresponds to a given parameter). The function will also use the specified reference data (e.g. group norm) of previously participating customers, for determining the results of the presently participating customers for parameters that are associated with the entity of interest, even though the specified parameter has not been explicitly presented to the user. Note that the domain of “car”, the entity “Skoda™”, and the implicit parameters “emotion” and “relationship” were provided as examples and are by no means binding.

Bearing all this in mind, attention is drawn to FIG. 4D, illustrating a flow chart of a non-correlation processing, in accordance with certain embodiments of the invention. Thus, at the onset the data that pertains to the subgroup selections of the participants is collected (4001 to 4003), and thereafter reference data (in respect of previous user sub-group selections) and their correspondence to respective at least one parameter is extracted from database 4004. Then, a non-correlation function is applied (4005) in respect of said at least one parameter for determining the level of correspondence between the parameters (e.g. “emotion” or “relationship” and the entity (e.g. Skoda™) in respect of the plurality of users (participated in steps 4001 to 4003). Other parameters may refer to e.g. “Rationality” and “Body”.

For a better understanding of the foregoing, there follows a non-limiting example of the non-correlation operation in respect of the parameter “vitality”.

The data is collected from n=1800 Czech Republic 18+ respondents with confidence interval: max. ±2.34% on 95% significance level (for a frequency of 50%).

The following sub-group selection were received by the respondents, where the numbers 0-7 represent the following colors:
0—Gray
1—Blue
2—Green A
3—Red
4—Yellow
5—Violet
6—Brown
7—Black

| Selection of | Sub-group selection- |
|---|---|
| 234 | 143 |
| 123 | 101 |
| 145 | 98 |
| 236 | 83 |
| 134 | 68 |
| 345 | 68 |
| 012 | 68 |
| 135 | 50 |
| 124 | 47 |
| 137 | 42 |
| 013 | 39 |
| 125 | 37 |
| 346 | 37 |
| 347 | 36 |
| 034 | 25 |
| 235 | 23 |
| 024 | 22 |
| 127 | 21 |
| 245 | 20 |
| 136 | 20 |
| 126 | 19 |
| 246 | 19 |
| 237 | 18 |
| 014 | 14 |
| 023 | 14 |
| 146 | 8 |
| 247 | 8 |
| 147 | 7 |

Thus, for instance, the sub-group selection of “green” “red” and “yellow” (234) was selected by 143 participants. Note that not all the sub-group selections from among the 56 available choices were selected.

In the next step, a Group Norm For Parameter Vitality is extracted from the database. The Group Norm has been obtained from applying the specified test for previous groups of respondents, for instance 27.288.

Next, the following function is applied for the parameter Vitality:

((Count(2-3-4)+Count(1-3-4)+Count(5-3-4)+Count(6-3-4)+Count(3-0-4)+Count(7-3-4))/(3*(Count(1-2-4)+Count(2-3-4)+Count(1-2-3)+Count(1-3-4))+Count(5-2-4)+Count(6-2-4)+Count(2-0-4)+Count(7-2-4)+Count(5-2-3)+Count(6-2-3)+Count(2-0-3)+Count(7-2-3)+Count(5-1-3)+Count(6-1-3)+Count(1-0-3)+Count(7-1-3)+Count(5-1-2)+Count(6-1-2)+Count(1-0-2)+Count(7-1-2)+Count(5-1-4)+Count(6-1-4)+Count(1-0-4)+Count(7-1-4)+Count(5-3-4)+Count(6-3-4)+Count(3-0-4)+Count(7-3-4))*100.0−27.288)/27.288* 100.0

$$\begin{matrix}Result of Vitality = \begin{matrix}( ( 143 + 68 + 68 + 37 + 25 + 36 ) / ( 3 * \\ ( 47 + 143 + 101 + 68 ) + 20 + 19 + 22 + 8 + \\ 23 + 83 + 14 + 18 + 50 + 20 + 3 + 9 + 42 + \\ 37 + 19 + 68 + 21 + 98 + 8 + 14 + 7 + 68 + \\ 25 + 36 ) * 100 - 27.288 ) / 27.288 * 100\end{matrix} \\ = ( 377 / ( 3 * 359 + 759 ) * 100 - 27.288 ) / 27.288 * 100 \\ = ( 377 / 1836 * 100 - 27.288 ) / 27.288 * 100 \\ = - 24 , 751652509598256058669599635678\end{matrix}$$

Note that for other parameters respective other functions are used. Note also that in accordance with certain embodiments different functions may be used in the case of using different number of sub-group selections (say four colors) or, e.g. in the case of a sub-group that amounts for the entire group of 8 colors (when the respondents order the 8 colors as per their respective choices).

Having finalized correlation and non-correlation calculation, attention is drawn to FIG. 5 illustrating a flow chart of a normalizing sequence of operation for reporting results, in accordance with certain embodiments of the invention. Thus, based on the results obtained by the correlation and non-correlation calculations 51 (as described with reference to FIGS. 4A-D above), a normalization sequence is applied 52 and 53. Initially, by this embodiment, there is a need to adjust the margins, i.e. minimal value, maximal value and middle value) Thus, assuming that the domain for the correlation extends over the range of −1 to 1 D(f)=<−1,1> and further assuming that the distribution of the correlation results (for the entire tested population ranges from 0.1 to 1 (54), then a new minimal 0.1 and maximal 1 values are set (step 52) and the result values are appropriately re-calculated and normalized to extend over the new margins (step 53; see also 55).

For a better understanding of the foregoing, there follows a non-limiting example of normalizing the non-correction parameter result for the parameter “vitality” that was exemplified with reference to FIG. 4D. As may be recalled the non-correlation result was

−24,751652509598256058669599635678

As the onset limits for parameter “Vitality” are obtained from the database:

minValue×−86,762

maxValue=96,55239

middleValue=27,288 (which was the specified group Norm).

Then, there commences a result normalization sequence, e.g. as follows:

1) For middleValue

a) if value is smaller or equal than new middle:

value=((computedValue−minValue)/Math.abs(middleValue−minValue))*((maxValue−minValue)/2)+minValue

b) if value is larger than new middle:

value=((computedValue−middleValue)/Math.abs(maxValue−middleValue)}*((maxValue−minValue)/2)+minValue+((maxValue−minValue)/2)

2) normalizedValue=(((value−minValue)/(Math.abs(maxValue−minValue)))*(maxInterval−minInterval))+minInterval

a) if normalized Value<minInterval=>normalized Value=minInterval

b) if normalizedValue>maxInterval=>normalizedValue=maxInterval

maxInterval and minInterval means new domain of function (e.g. min=0, max=100)

Applying this exemplary normalization sequence of operation yields:

computedValue==−24,751652509598256058669599635678 (as calculated with respect to non-correlation parameter “vitality”, above)

minValue=−86,762

maxValue=96,55239

middleValue=27,288

maxInterval=100 new maximal value for vitality

minInterval=0 new minimal value for vitality

a) computedValue<middleValue,

$$\begin{matrix}value = ( ( - 24 , 751652 + 86 , 762 ) / ABS ( 27 , 288 + 86 , 762 ) ) * \\ ( ( 96 , 55239 + 86 , 762 ) / 2 ) - 86 , 762 \\ = ( 62 , 010348 / 114 , 05 ) * 91 , 657195 - 86 , 762 \\ = - 36 , 926887692644804910127137220517\end{matrix} \\ 2 )$$

$$\begin{matrix}normalized Value = ( ( ( - 36 , 926887692644804910127137220517 + \\ 86 , 762 ) / ( 96 , 55239 + 86 , 762 ) ) * ( 100 ) ) \\ = 49 , 835112307355195089872862779483 / \\ = 183 , 31439 * 100 \\ = 27 , 185597544936431389741341516879\end{matrix}$$

The latter normalized value is normalized to the scale of 0 to 100. The invention is not bound by the specified result normalization sequence of operations and also not by the 0 nd 100 margins.

Whereas, for convenience of explanation, the description mainly referred to market research in respect of entity that represents car manufacturer, those versed in the art will readily appreciate that the invention may likewise be applied to an entity that represents desired product and/or service or the like. Moreover, the invention was exemplified with reference to a concept or object represented as word but those versed in the art that the invention is not bound by this particular type of object/concept. For instance, the invention may use other object types such as word phrases (combination of two or more words e.g. noun phrase), sound, image, video, multimedia and/or a combination thereof. For instance, a given concept may be represented by two objects, where one is a noun phrase and the other is a video clip. Those versed in the art will further appreciate that the specific correlation and/or non-correlation functions (techniques) were provided by way of example only and are by no means binding. In accordance with certain embodiments the functions technique may be applied to sub-group selection in the raw form or if desired variants thereof (both encompassed by the term sub-group selections). For instance in accordance with certain embodiments there may be given different weight to different sub-groups selections.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a machine-readable memory tangibly embodying a program of instructions executable by the machine for executing the method of the presently disclosed subject matter.

What is claimed is:

1. A market research computer implemented method for evaluating correlation between an entity and at least one concept associated with the entity, comprising:
a) sending from a database, to each user of a plurality of users data indicative of the entity and the at least one concept associated therewith;
b) repeatedly performing for each user of said plurality of users:
(i) collecting from the user data indicative of sub-group of color selections, from a predefined group of colors, for said entity and the at least one concept, respectively;
c) creating a data structure representing Color Association (CA) profiles respectively for each concept of said at least one concept by aggregating selections of sub-groups of colors of the plurality of users in respect of said concept;
d) creating a data structure representing a Color Association (CA) profile for said entity by aggregating sub-groups of color selections of the plurality of users in respect of said entity;
e) calculating correlation between a CA profile of at least one of said concepts and the CA profile of said entity; and
f) reporting correlation results indicative on how the plurality of users conceive the correlation between the entity and each one of the at least one concept.

2. The method according to claim 1, wherein
said (e) includes; transforming said correlation results into graphical indicators.

3. The method according to claim 1 wherein said aggregating includes designating the number of users that selected each sub group of colors respectively.

4. The method according to claim 1, wherein each concept is represented by a member of a group mat includes: a word, a word phrase, an image, a sound, video, a multi-media.

5. The method according to claim 1, wherein at least one of said concepts is associated with least two objects and said method further comprising in respect of each one of the concepts
said (b) includes
(b1) repeatedly performing for each user of said plurality of users:
(i) collecting from the user data indicative of sub-group of color selections, from a predefined group of colors, for said at least two objects, respectively;
and wherein said (d) includes
(d1) (i) creating a Color Association (CA) profiles respectively for each object of said at least two objects by aggregating sub-groups of color selections of the plurality of users in respect of said concept;
(ii) creating a CA profile for the concept that is associated with said at least two objects, including normalizing the CA profile of said concept;
and wherein said (e) includes
e1) calculating correlation between the normalized CA profile of said concept and the CA profile of said entity; and wherein said (f) includes
f1) reporting correlation results indicative on how the plurality of users conceive the correlation between the entity and said concept, that is associated with at least two objects.

6. The method according to Claim 5, wherein each object is represented by a member of a group that includes: a word, a word phrase, an image, a sound, video, a multi-media.

7. The method of claim 1 wherein said predefined group of colors includes eight colors.

8. The method of claim 1 wherein said sub-group of colors includes three colors.

9. The method of claim 1, wherein said correlation utilizes the Piersan correlation technique.

10. The method according to claim i, wherein said entity being represents a car brand.

11. A market research computer implemented method for evaluating at least one parameter associated with an entity, comprising:
a) sending from a database a collection of reference sub-group selections in respect of at least one parameter associated with said entity;
b) repeatedly performing for each user of said plurality of users;
(i) collecting from the user data indicative of sub-group color selections, from a predefined group of colors, for said entity;
c) calculating a non-correlation function in respect of the user sub-group selections using data that is obtained from the reference sub-group selections, wherein said function corresponds to a parameter, and determining the level of correspondence between the parameter and said entity in respect of said plurality of users; and
d) reporting correspondence results indicative on how the plurality of users conceive the correspondence between the entity and each one of the at least one parameter.

12. The method according to claim 11, wherein each parameter is represented by a member of a group that includes: a word, a word phrase, an image, a sound, video, a multi-media.

13. The method of claim 11, wherein said predefined group of colors includes eight colors.

14. The method of claim 11 wherein said sub-group of colors includes three colors.

15. A market research computer implemented system for evaluating correlation between an entity and at least one concept associated with the entity in respect of a plurality of users, comprising:
an analyzer module is configured to provide a data structure representing Color Association (CA) profiles respectively for each concept of said at least one concept by aggregating sub-groups of color selections of the plurality of users in respect of said concept;
the analyzer module is further configured to provide a data structure representing a Color Association (CA) profile for said entity by aggregating sub-groups of color selections of the plurality of users in respect of said entity;
said analyzer module is configured to calculate correlation between a CA profile of at least one of said concepts and the CA profile of said entity; and
a report module coupled to said analyzer module and being configured to report on correlation results indicative on how the plurality of users conceive the correlation between the entity and each one of the at least one concept.

16. The system according to Claim 15, further comprising a scanner control module coupled to said analyzer module and being configured to send to each user of a plurality of users data indicative of the entity and the at least one concept associated therewith; said scanner control module is configured to extract said data from a database;
said scanner control module is further configured to collect from said plurality of users data indicative of sub-group of color selections, from a predefined group of colors, for said entity and the at least one concept, respectively.

17. The system according to claim 15, further comprising
Said analyzer module is further configured to calculate a non-correlation function between the user sub-group selections and the reference sub-group selections in respect of said at least one parameter and determining the level of correspondence between the parameters and said entity in respect of said plurality of users; and
said report module is further configured to report on correspondence results indicative on how the plurality of users conceive the correspondence between the entity and each one of the at least one parameter.

18. A program storage device readable by machine, tangibly embodying a program of instructions executable by the machine to perform method steps for computer implemented market research, comprising:
a) sending from a database, to each user of a plurality of users data indicative of the entity and the at least one concept associated therewith;
b) repeatedly performing for each user of said plurality of users:
(i) collecting from the user data indicative of sub-group of color selections, from a predefined group of colors, for said entity and the at least one concept, respectively;
c) creating a data structure representing Color Association (CA) profiles respectively for each concept of said at least one concept by aggregating selections of sub-groups of colors of the plurality of users in respect of said concept;
d) creating a data structure representing a Color Association (CA) profile for said entity by aggregating sub-groups of color selections of the plurality of users in respect of said entity;
e) calculating correlation between a CA profile of at least one of said concepts and the CA profile of said entity; and
f) reporting correlation results indicative on how the plurality of users conceive the correlation between the entity and each one of the at least one concept.

19. A program storage device readable by machine, tangibly embodying a program of instructions executable by the machine to perform method steps for computer implemented market research, comprising:
a) sending from a database a collection of reference sub-group selections in respect of at least one parameter associated with said entity;
b) repeatedly performing for each user of said plurality of users:
(i) collecting from the user data indicative of sub-group color selections, from a predefined group of colors, for said entity;
c) calculating a non-correlation function in respect of the user sub-group selections using data that is obtained from the reference sub-group selections, wherein said function corresponds to a parameter, and determining the level of correspondence between the parameter and said entity in respect of said plurality of users; and
d) reporting correspondence results indicative on how the plurality of users conceive the correspondence between the entity and each one of the at least one parameter.
